(19) United States
(12) Patent Application Publication
(10) Pub. No.: US 2018/0352394 A1
(43) Pub. Date: Dec. 6, 2018

(54) SERVICES FOR MESSAGING APPLICATION WITH IN-BUILT WEB SEARCH

(71) Applicant: MessageCube Corp Inc., Sunnyvale, CA (US)

(72) Inventors: Jianrong LI, Sunnyvale, CA (US); Cristina HOU, Sunnyvale, CA (US)

(21) Appl. No.: 15/993,534

(22) Filed: May 30, 2018

Related U.S. Application Data
(60) Provisional application No. 62/513,378, filed on May 31, 2017.

(51) Int. Cl. H04W 4/14; H04W 4/20; H04L 29/08; G06F 17/30; G06F 9/54

(52) U.S. Cl. CPC H04W 4/14; H04W 4/20; G06F 9/547; G06F 17/30867; H04L 67/04

(57) ABSTRACT

A method of providing services for a messaging application with in-built web search is performed by an internet server. The internet server receives a query request from the messaging application of a first user device and then processes the query request. Processing the query request includes communicating with one or more internet services to obtain query results. The internet server generates an encoded message that includes a reference to the query results and maintains a database that correlates the reference with the query results. The internet server then forwards a query response, including the query results and the encoded message, to the first user device. The reference to the query results are subsequently received at the internet server from a second user device. The internet server forwards the one or more query results to the second user device based on the received reference.

### CROSS-REFERENCE TO RELATED APPLICATION

This application claims the benefit of U.S. Provisional Application No. 62/513,378 entitled “SMS Internet Access System,” filed May 31, 2017 and expressly incorporated herein by reference in its entirety.

### BACKGROUND

People often communicate with each other by electronic messages. For example, people may exchange text messages with the Short Message Service (SMS) protocol or via various instant messaging (IM) systems. Historically, SMS was effectively the only way to send a text message from a cellular phone. The messages sent via SMS are subject to strict size limits, and the sending of such messages were charged by phone carriers at SMS-specific rates. However, many modern cell phones have internet connectivity and the ability to participate in a wide variety of communication protocols, such as Hypertext Transfer Protocol (HTTP). HTTP has the ability to send content that has a wide variety of features (e.g., links, photos, audio, etc.) and allows messages of arbitrary length. Additionally, an HTTP message can be sent between any devices that are addressable on the Internet. Such messages are sent using the devices' ordinary Internet service (thereby avoiding the use of SMS-specific pricing, and avoiding any limitations associated with SMS systems).

While messages sent via HTTP often provide richer content, SMS continues to have legacy influence. Many phones have Internet service and can communicate by HTTP, but nearly all phones have SMS. When one person wants to send a message to another, the user often does not know what capabilities are available on the recipient's phone, so the sender often sends an SMS message in order to be able to reach the recipient without regard to what type of device the recipient has. But the decision to use SMS subjects the message to SMS's limitations.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture of a wireless communication network.

FIG. 2 illustrates examples of user equipments (UEs).

FIG. 3 illustrates an example internet server.

FIG. 4 is a message flow diagram of an example process for providing services for a messaging application with in-built web search.

FIG. 5 is a diagram illustrating an example encoded message.

FIG. 6 is a diagram illustrating an example table for correlating one or more references to one or more query results maintained by an internet server.

FIG. 7 is a flow chart illustrating an example process for providing services for a messaging application with in-built web search.

FIG. 8 is an example user interface of a messaging application with in-built web search.

FIG. 9 is an example user interface of a messaging application with in-built web search with user interface components for selecting one or more internet services.

FIG. 10 is an example user interface of a messaging application with in-built web search with user interface components for providing user input for one or more search terms.

FIG. 11 is an example user interface of a messaging application with in-built web search with user interface components for displaying query results.

FIG. 12 is an example user interface of a messaging application with in-built web search with user interface components for sending multiple query results to another user device.

FIG. 13 is an example user interface of a messaging application with in-built web search for displaying additional information of a query result and user interface components for sending a single query result to another user device.

FIG. 14 is an example user interface of a messaging application with in-built web search for displaying query results as multimedia content received from another user device.

FIG. 15 is an example user interface of a messaging application without in-built web search for displaying an encoded message providing a reference to query results as a text message received from another user device.

FIG. 16A is an example user interface of a messaging application with user interface components for allowing the generation of transient messages that include text.

FIG. 16B is an example user interface of a messaging application with user interface components for allowing the generation of transient messages that include other content such as an image.

FIG. 17 is an example user interface of a messaging application for displaying transient text messages.

FIG. 18 is an example user interface of a messaging application for displaying a reference to a transient text message.

FIG. 19 illustrates an example user interface of a web browser for displaying a transient text message.

FIG. 20 illustrates an example user interface of a web browser for displaying a transient text message after expiration of a maximum time period.

### DETAILED DESCRIPTION

Aspects of the present disclosure are directed to computing platforms (i.e., user equipment, internet server, etc.), computer-readable media, and processes for providing services for a messaging application with in-built web search.

As mentioned above, many user devices, such as cellular phones, smart phones, laptops, etc. include the ability to provide a user with internet access, such as through a web browser that communicates via one or more communication protocols, such as Hypertext Transfer Protocol (HTTP). In many instances, a user may desire to share internet content with another user. For example, a user may access an internet service (e.g., internet search engine, internet retailer, internet social networking service, etc.) to search for various content via a web browser, which the user then wishes to share with another user (e.g., friend, family member, co-worker, etc.). However, sharing the content typically requires the user to switch between applications. For example, a user may be required to copy a uniform resource locator (URL) from within a web browser application and then switch to a separate messaging application, where the URL may then be pasted into a message to send to one or more contacts from within the messaging application.

Furthermore, the URL copied into a messaging application may render the message incompatible with the messaging protocol utilized by the messaging application. For example, as mentioned above, certain messaging protocols may be subject to strict size limits (e.g., Short Message Service (SMS) protocol limited to 140 bytes (140 bytes*8 bits/byte=1120 bits). SMS messages can be encoded using a variety of alphabets: the default GSM 7-bit alphabet, the 8-bit data alphabet, and the 16-bit UCS-2 alphabet. Depending on which alphabet is utilized by the messaging application, this leads to the maximum character limit of 160 7-bit characters, 140 8-bit characters, or 70 16-bit characters. Thus, incorporating a native URL obtained via the web browser into a messaging application may result in a message that exceeds the maximum character limit of the messaging protocol utilized by the messaging application.

Accordingly, aspects of the present disclosure include providing services for a messaging application that includes in-built web search functionality. As will be described in further detail below, a messaging application with in-built web search may be installed on a user device, where the messaging application provides the user with the ability to query one or more internet services from within the messaging application, itself (e.g., without the need to switch to a separate web browsing application). The results of the query are then displayed within the messaging application, where the user may then select one or more of the query results to forward as a message to another user. In some aspects, the messaging application communicates with an internet server who performs the initial query and generates an encoded message. The encoded message is formatted, by the internet server, to comply with the messaging protocol that is utilized by the messaging application. By way of example, the encoded message generated by the internet server may include text that identifies one or more search terms used for the query, a short description or additional information about the query results, and a reference to the query results. In some aspects, the reference to the query results may be in the form of a URL that is dynamically generated by the internet server. The messaging application may then send the encoded message to another user via the messaging protocol (e.g., SMS). The recipient of the encoded message may then access the query results by way of the reference included in the encoded message (e.g., by displaying the query results within a compatible messaging application, or by activating a web browser via the URL included in the encoded message). These and other aspects will be described in further detail below.

A user device, or user equipment (UE), may be mobile or stationary, and may communicate with a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

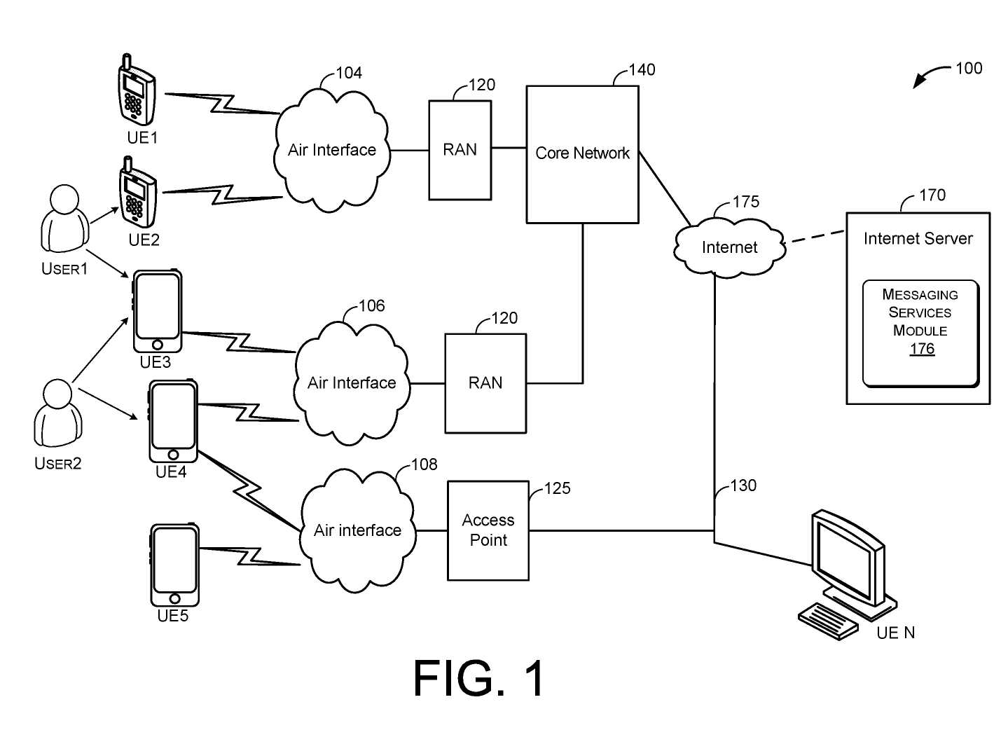

FIG. 1 illustrates a high-level system architecture of a wireless communication network 100 in accordance with various aspects. The wireless communication network 100 contains UEs 1 . . . N. The UEs 1 . . . N can include mobile phones, personal computers (e.g., a laptop computer, desktop computer, etc.), television receivers (e.g., a television, streaming device, digital video recorder, etc.), voice-activated virtual assistants, gaming consoles, and so on. For example, in FIG. 1, UEs 1 . . . 2 are illustrated as cellular mobile phones, UEs 3 . . . 5 are illustrated as cellular touchscreen mobile phones or smart phones, and UE N is illustrated as a desktop computer or laptop.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection 130. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of Wi-Fi or 802.11-based network). The Internet 175 can thereby function to bridge packet-switched data communications between UE N and UEs 1 . . . 5 via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a direct wired connection 130 to the Internet 175, such as a direct connection to a modem or router, which can correspond to the access point 125 itself in an example (e.g., for a Wi-Fi router with both wired and wireless connectivity).

The core network 140 is configured to support one or more communication services (e.g., Voice-over-Internet Protocol (VoIP) sessions, Push-to-Talk (PTT) sessions, group communication sessions, social networking services, SMS messaging, RCS messaging, MMS messaging, etc.) for UEs that can connect to the core network 140 via the RANs 120 and/or via the Internet 175, and/or to provide content (e.g., web page downloads) to the UEs.

Referring to FIG. 1, an internet server 170 is shown as connected to the Internet 175. In some aspects, the internet server 170 is owned and operated by an entity that is separate from the mobile network operator (e.g., operator of core network 140). In other aspects, the internet server 170 may be in direct communication and/or incorporated within core network 140, itself. The internet server 170 can be implemented as a plurality of structurally separate servers, or alternately may correspond to a single server.

According to aspects of the present disclosure, one or more of the various UEs 1-N illustrated in FIG. 1 may include a locally-installed messaging application that includes an in-built web search functionality. Accordingly, the internet server 170 includes a messaging services module 176 that is configured to communicate with the messaging application. In some aspects, the messaging services module 176 is configured to perform a web search on behalf of the messaging application. In another aspect, the messaging services module 176 may generate and return an encoded message to the messaging application, where the encoded message is formatted to be compliant with a messaging protocol utilized by the messaging application. The messaging application may then send the encoded message to another user (i.e., the recipient) via the messaging protocol (e.g., SMS protocol). Furthermore, the encoded message may include a reference to the web search results which may be used by the recipient to communicate with the internet server 170 to retrieve the same web search results.

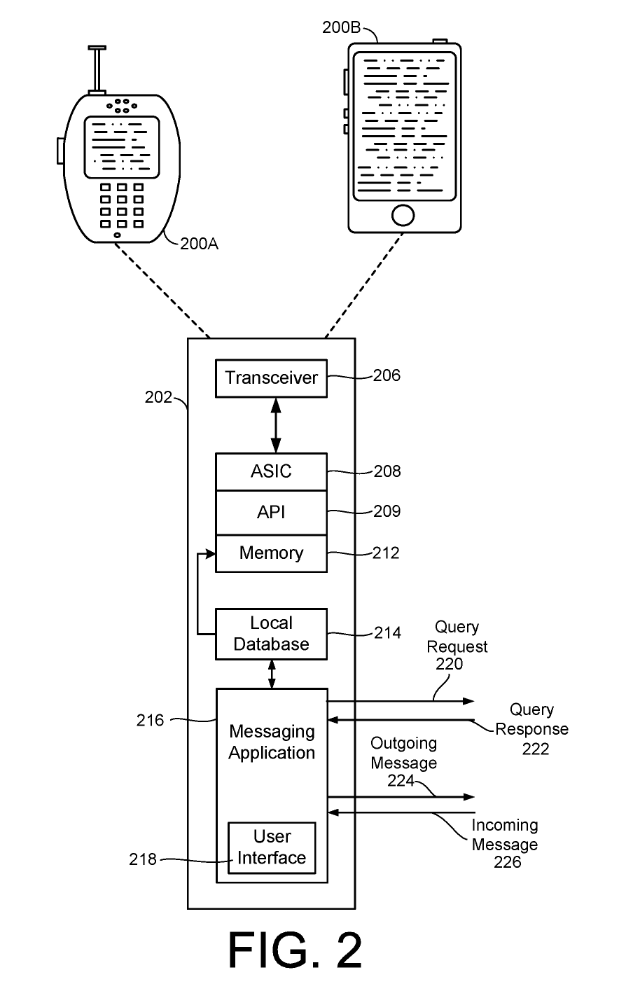

FIG. 2 illustrates examples of UEs (i.e., user devices) in accordance with embodiments of the present disclosure. UEs 200A and 200 B are possible implementations of any of the UEs 1-N of FIG. 1. The various device types illustrated in FIG. 2 include a mobile phone (e.g., UE 200A) and smart phone (e.g., UE 200B).

UEs 200A and 200B, may also be referred to as cellular phones and includes portable telephones that can make and receive calls over a radio frequency link while the user is moving within a telephone service area.

While internal components of UEs such as the UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., internet server 170, web URLs, etc.). The platform 202 can also independently execute locally stored applications without RAN interaction. The platform 202 can include a transceiver 206 operably coupled to an application specific integrated circuit (ASIC) 208, or other processor, microprocessor, logic circuit, or other data processing device. The ASIC 208 or other processor executes the application programming interface (API) 209 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can store applications not actively used in memory 212, as well as other data. The local database 214 is typically a flash memory cell, but can be any secondary storage device as known in the art, such as magnetic media, EEPROM, optical media, tape, soft or hard disk, or the like.

Accordingly, an embodiment of the invention can include a UE (e.g., UE 200A-B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, the platform 202 is illustrated as including a messaging application 216. Messaging application 216 may be a messaging application that is configured to generate outgoing messages 224 and to receive incoming messages 226. In some aspects, outgoing messages 224 and/or incoming messages 226 are sent/received via a messaging protocol, including, for example, short message services (SMS) protocol, multimedia messaging services (MMS) protocol, and/or rich communication services (RCS) protocol. A user interface 218 provided by the messaging application 216 may be configured to present the outgoing messages 224 and incoming messages 226 via a display included the UE.

Furthermore, as discussed above, the messaging application 216 may be configured to provide in-built web search capabilities. That is, the messaging application 216 may provide one or more user interface components via user interface 218 to allow a user to enter one or more search terms within the messaging application 216, itself. The messaging application 216 may incorporate the search terms into a query request 220 which is then sent to the internet server 170. In one example, the query request 220 is communicated to the internet server via the internet 175. The messaging application 216 may then receive a query response 222 from the internet server 170 (e.g., via internet 175). The query response 222 may include one or more query results, which may be displayed to the user via user interface 218. In some aspects, the query results include text, images, audio, video, animations, and/or any combination thereof. The query response 222 may also include one or more encoded messages that are generated by the internet server 170. The encoded message may include a reference to the query results and is formatted according to a messaging protocol utilized by the messaging application 216. Thus, rather than sending the query results directly to another user device, the messaging application 216 may, instead, send the encoded message as an outgoing message 224 via the messaging protocol. The recipient of the encoded message may then use a reference included in the encoded message to retrieve the query results from the internet server 170.

Thus, in some aspects, the ASIC 208, memory 212, API 209, local database 214, and messaging application 216 may all be used cooperatively to load, store and execute the various functions disclosed herein and thus the logic to perform these functions may be distributed over various elements. Alternatively, the functionality could be incorporated into one discrete component. Therefore, the features of the UEs 200A and 200B in FIG. 2 are to be considered merely illustrative and the invention is not limited to the illustrated features or arrangement.

The wireless communication between the UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. Voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

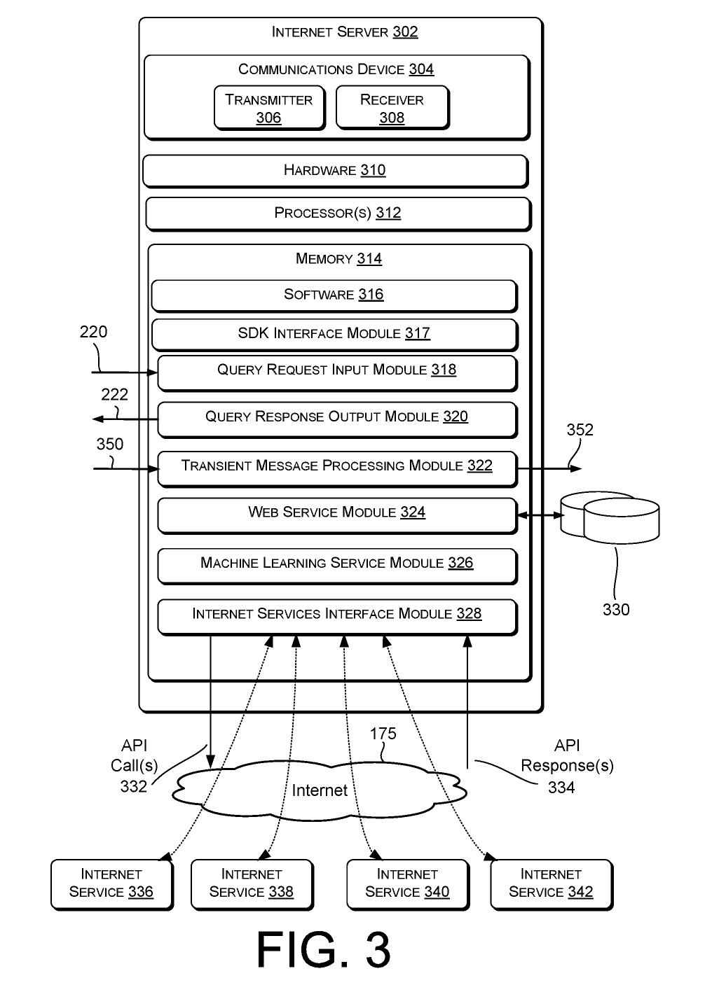

FIG. 3 illustrates an example internet server 302. Internet server 302 is one possible implementation of internet server 170 of FIG. 1. The components illustrated in FIG. 3 may be implemented in different types of apparatuses in different implementations (e.g., in an ASIC, in an SoC, etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different messaging protocols.

The internet server 302 may include at least one communication device (represented by the communication device 304) for communicating with other nodes. For example, the communication device 304 may comprise a network interface that is configured to communicate with one or more network entities via a wire-based or wireless links. In some aspects, the communication device 304 may be implemented as a transceiver configured to support wire-based or wireless signal communication. This communication may involve, for example, sending and receiving: messages, parameters, or other types of information. Accordingly, in the example of FIG. 3, the communication device 304 is shown as comprising a transmitter 306 and a receiver 308.

The internet server 302 may also include other components that may be used in conjunction with the operations as taught herein. For example, the internet server 302 may include hardware 310, one or more processors 312, and memory 314.

The hardware 310 may include additional hardware interfaces, data communications, and/or data storage hardware. For example, the hardware interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 314 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism.

The processor 312 of internet server 302 may execute instructions and perform tasks under the direction of software components that are stored in memory 314. For example, the memory 314 may store various software components that are executable or accessible by the one or more processors 312 of the internet server 302. The various components may include software 316, a software development kit (SDK) interface module 317, a query request input module 318, a query response output module 320, a transient message processing module 322, a web service module 324, a machine learning service module 326, and an internet services interface module 328. The software 316, SDK interface module 317, query request input module 318, query response output module 320, transient message processing module 322, web service module 324, machine learning service module 326, and internet services interface module 328, collectively, may be one possible implementation of messaging services module 176 of FIG. 1.

The software 316, query request input module 318, query response output module 320, transient message processing module 322, web service module 324, machine learning service module 326, and internet services interface module 328 may include routines, program instructions, objects, and/or data structures that perform particular tasks or implement particular abstract data types. For example, the query request input module 318 may include one or more instructions, which when executed by the one or more processors 312 direct the internet server 302 to perform operations related to the receiving one or more query requests 220 from the messaging application 216 of a user device (e.g., platform 202 of FIG. 2). As mentioned above, the query request 220 may be received from the messaging application 216 via the internet 175 and may include one or more search terms.

The internet services interface module 328 may include one or more instructions, which when executed by the one or more processors 312 direct the internet server 302 to perform operations related to performing a query with one or more internet services (e.g., internet services 336-342). In one aspect, the internet services interface module 328 may communicate with one or more internet services over the internet 175 via a plurality of application programming interfaces (APIs) provided by the internet services 336-342.

The internet services 336-342 may include any service provided over the internet such as an internet search engine (e.g., BING), an internet retailer (e.g., AMAZON), an internet directory service (e.g., YELP), an internet database (e.g., GIPHY), an internet review service (e.g., ROTTEN TOMATOES), an internet news service (e.g., AP NEWS), an internet classified advertisements service (e.g., EBAY), an internet dating service (e.g., EHARMONY), an internet blog service, an internet forum service, an internet social networking service (e.g., FACEBOOK), an internet media sharing service (e.g., YOUTUBE), and an internet wiki service (e.g., WIKIPEDIA).

In operation, the internet services interface module 328 may select an API from among a plurality of APIs, where the selected API corresponds to at least one of the internet services 336-342. In some examples, the selected API corresponds to a plurality of internet services 336-342. That is, a single API may be selected for communicating with a plurality of internet services 336-342. In yet another example, the internet services interface module 328 may select a plurality of APIs corresponding to an aggregation of several internet services 336-342. For example, in response to a query request for a shopping-related search for a product, the internet services interface module 328 may select multiple APIs, each corresponding to an internet retailer (e.g., in response to receiving a search term “shoes” internet services interface module 328 may select a first API for communicating with a first internet retailer (NORDSTROMS), a second API for communicating with a second internet retailer (SAKS), and a third API for communicating with a third internet retailer (MACYS)). The internet services interface module 328 may then generate an API call 332 based on the selected API(s), where the API call 332 incorporates one or more of the search terms included in the query request 220 received from the messaging application 216. The internet services interface module 328 may then receive an API response 334 from the corresponding internet service, where the API response 334 includes one or more query results. By way of example, assume the query request 220 includes a search term “coffee”. The internet services interface module 328 may then generate an API call 332 for an internet directory service (e.g., YELP), where the API call includes the search term “coffee”. The internet service interface module 328 may then receive an API response 334 from the internet directory service that identifies one or more coffee shops as well as additional information related to the coffee shops (e.g., location, description, ratings, etc.).

In one aspect, selecting which of the internet services 336-342 to query is based on user input received via the messaging application 216. That is, the messaging application 216 may provide a user interface that allows the user to select one or more internet services along with the associated search terms. Thus, the query request 220 may not only include the search terms, but may also include an indication of which internet service was selected by the user. Accordingly, the internet services interface module 328 may be configured to select an API from among a plurality of known APIs based, at least in part, on the indication of the selected internet service included in the query request 220. In some examples, the user may select multiple internet services for performing a search (e.g., MACYS, SAKS, and NORDSTROMS). Thus, in at least one aspect, the query request 220 includes an indication of multiple internet services that were selected by the user. In response, the internet services interface module 328 may select a respective API for each of the internet services indicated in the query request 220.

In some examples, the API response 334 may include a large number of query results. Accordingly, the internet server 302 may be configured to select a subset of the received query results. In one example, the internet server 302 is configured to select which of the received query results are the most relevant. In some aspects, determining which of the query results are the most relevant may be performed by applying a machine learning technique to the received query results to obtain a smaller list/subset of query results.

By way of example, the machine learning service module 326 may include one or more instructions, which when executed by the one or more processors 312 direct the internet server 302 to perform operations related to applying one or more machine learning techniques to the query results included in the API response 334 to obtain the most relevant query results.

In some examples, the machine learning service module 326 may implement a machine learning technique that is a supervised, unsupervised, or a reinforcement learning technique. Examples of supervised learning techniques include K-nearest neighbor (KNN), Naive Bayes, logistic regression, support vector machine (SVM), and others. Other supervised learning analysis techniques include linear or polynomial regression analysis, decision tress analysis, and random forests analysis. Examples of unsupervised learning analysis techniques include association analysis, clustering analysis, dimensionality reduction analysis, hidden Markov model analysis techniques, and others. Examples of clustering analysis techniques include K-means, principal component analysis (PCA), singular value decomposition (SVD), incremental clustering, and probability-based clustering techniques. The reinforcement learning technique may be, for example, a Q-learning analysis technique. The techniques described above are some examples of machine learning techniques that may be utilized by the machine learning service module 326 to determine which, if any, of the query results included in the API response 334 are to be provided to the user. These are not intended to be limiting.

In one example, the machine learning service module 326 is configured to collect a sufficient number (hundreds if not thousands) of training API responses 334 to train a deep learning method so that it functions well, and so is considered “strong.” In one embodiment, category-specific training documents are passed to, and ingested by, one or more deep learning methods best suited to handle natural language processing (NLP). The method more commonly used in the context of NLP and text analysis, are known to practitioners in the art as a recurrent neural networks (RNN). Such deep learning RNNs use hidden computational “nodes” and various “gates,” and require manipulation known in the art as “tuning.” After the process of “tuning”, the method will be evaluated to assess the degree to which it accurately identifies the textual test data it has never before encountered with the “vector space” it has been trained to recognize. When the system is trained to “understand” a particular type of query request 220, it may be thought of as a “filter.” Typically, the system will consist of more than one filter. The system passes the enterprise data through each filter. For example, there can be a filter for GOOGLE queries and another filter for TWITTER queries, among others. Once the Deep Learning Engine is trained, the system indexes and also extracts text from each query and in any of the API responses 334. Those of skill in the art given the benefit of the present disclosure will appreciate that other implementations are contemplated.

In some examples, the machine learning service module 326 may be configured to operate in a non-real-time mode by extracting existing API responses, e.g. from the previous day's API responses, and then store the data in a database. In other embodiments, the machine learning service module 326 may operate in real-time to intercept, index, store and extract text from API calls 332 and/or API responses 334. After indexing, extracting text, and storing the API data in a database, the system passes that data to each of the category-specific methods, which are also referred to herein as “filters.” Each filter scores the data for each API response category for accuracy in comparison to how each filter was trained.

In some aspects, the machine learning service module 326 may also be configured to determine (e.g., calculate) a relevancy value for the query results based, in part, on the search terms used in the API call 332. The machine learning service module 326 may then select one or more query results from the API response 334 based on the determined relevancy value. The relevancy value may then be utilized by the machine learning service module 326 in determining which query results to include in the query response 222 sent to the messaging application 216 (e.g., query results with a higher relevancy value may be prioritized over query results with a lower relevancy value).

The web service module 324 may include one or more instructions, which when executed by the one or more processors 312 direct the internet server 302 to perform operations related to storing the one or more query results. In one example, the query results may be stored to memory 314. In another example, the web service module 324 may be configured to store the one or more query results to database 330. Furthermore, the web service module 324 may be configured to generate an encoded message that includes a reference to the one or more query results. The web service module 324 may also maintain the database 330 that correlates the dynamically generated reference with the one or more query results.

In general, the encoded message may be formatted by the internet server 302 according to a messaging protocol utilized by the messaging application 216. For example, assuming the messaging protocol utilized by the messaging application 216 includes a maximum character limit, then the internet server 302 may format the encoded message to include a number of characters that is equal to or less than the maximum character limit. Furthermore, as mentioned above, the encoded message may include a dynamically generated reference to the one or more query results. In one example, the internet server 302 is configured to format the reference included in the encoded message as a uniform resource locator (URL) to direct a user device to the internet server 302.

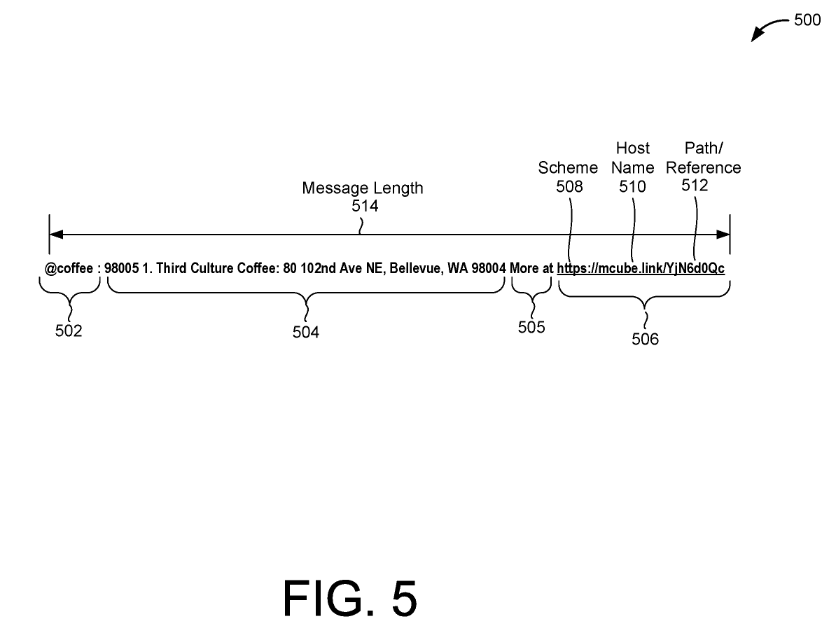

In some aspects, the internet server 302 is configured to generate multiple encoded messages, where each encoded message corresponds to a single query result included in the API response 334. For example, the internet server 302 may generate a first encoded message that includes a first reference to a first query result included in the API response 334. The internet server 302 may also generate a second encoded message that includes a second reference to a second query result included in the same API response 334. Further details regarding the encoded messages and included references are described below with respect to the example provided in FIG. 5.

Referring still to FIG. 3, the internet server 302 further includes a query response output module 320 that may include one or more instructions, which when executed by the one or more processors 312 direct the internet server 302 to perform operations related to forwarding/sending a query response 222 to the messaging application 216 of a user device. In some aspects, the query response 222 may include the one or more query results (e.g., results of a search performed by internet services interface module 328) based on the search term(s) included in the received query request 220. The query response 222 may also include one or more encoded messages (e.g., see encoded message 500 of FIG. 5) that include, in part, the references to the one or more query results. In some examples, the query request 220 and/or the query response 222 are communicated between the internet server 302 and the messaging application 216 over the internet 175 via one or more internet protocols (e.g., TCP/IP). As mentioned above, in some aspects, the internet server 302 may be configured to generate multiple encoded messages, where each encoded message corresponds to a single query result. Thus, in some implementations, the query response 222 may include the multiple encoded messages that are generated by the internet server 302.

The transient message processing module 322 may include one or more instructions, which when executed by the one or more processors 312 direct the internet server 302 to perform operations related to receiving a transient message package 350 from the messaging application 216. In some aspects, the transient message package includes content, an indication that the text message is to be transient (e.g., only lasting for a certain time period) and an indication of an intended recipient of the text message. In some aspects, the content included in the transient message package 350 includes a text message. However, in other examples, the content may include any media, video, audio, link, image, and/or file, that the user of messaging application 216 desires to share with another user. The transient message processing module 322 may store the content (e.g., in memory 314) and generate an encoded message 352 that includes a reference to the stored content. In some examples, the transient message package may also include a maximum time period that is associated with the content. As will be described below, the internet server 302 may be configured to begin a transient timer in response to the recipient accessing the content, where the internet server 302 may continue providing access to the content to the recipient only if the time period, as indicated by the transient timer, is less than or equal to the maximum time period associated with that content.

As mentioned above, the various software components included in memory 314 may include an optional SDK interface module 317. The SDK interface module 317 may include one or more instructions, which when executed by the one or more processors 312 direct the internet server 302 to perform operations related providing an access point/portal for developers/MNOs to provide them with the ability to include their content and/or customize the internet services provided to users via any messaging application including, but not limited to, messaging application 216 of FIG. 2.

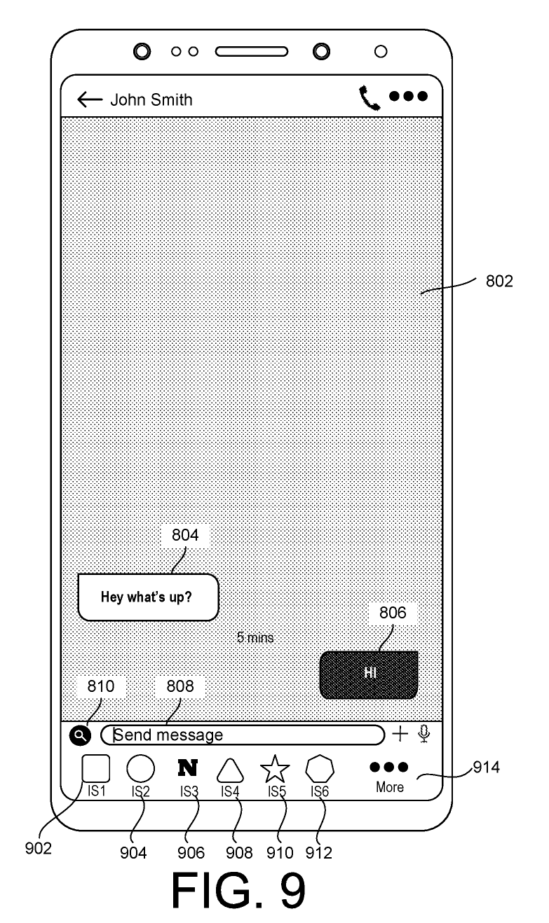

In one aspect, the SDK interface module 317 may be configured to provide a control dashboard, such as via a website, to allow MNOs, carriers, handset manufacturers, etc. with the ability to specify which internet services (e.g., internet services 902-912 of FIG. 9) will be shown and/or hidden. The control dashboard may also provide the ability for the MNOs, carriers, and/or handset manufacturers with the ability to specify the order in which the various internet services are displayed via the user interface 218 of messaging application 216. In some examples, the determination of which internet services are shown/hidden and/or the order in which internet services are displayed may be based on a model of the user device (e.g., phone model) and/or a build version of the user device.

The SDK interface module 317 may also be configured to provide an SDK extendable access point for developers of other applications (e.g., other applications installed on the user device) and or for developers of various internet services. The SDK extendable access point may be configured to allow a developer to integrate their services to an SDK provided by the internet server 302. The developer may then upload their software code to the internet server 302 via the SDK interface module 317 where once the software code is reviewed and approved, is released to the SDK. Once released, users of the messaging application 216 may then be able to see the developers content within the messaging application 216 (e.g., via the in-built search function).

As mentioned above, other apparatuses in a system may include components similar to those described to provide similar functionality. Also, a given apparatus may contain one or more of the components. For example, an apparatus, separate and distinct from internet server 302, may include one or more of the modules 317-328 illustrated in FIG. 3. By way of a particular example, the SDK interface module 317 may be incorporated into a structurally separate computing device (e.g., server) that may be configured to be communicatively coupled to internet server 302.

In other examples, one or more of the services provided by the modules illustrated in FIG. 3 may be hosted in a virtual machine on the cloud. In some cases, the internet server 302 may be on premises, or alternatively, may be hosted off premises. A service on the cloud may provide the services of part or all of internet server 302. Thus, internet server 302 may either be a physical dedicated server, or may be a virtual machine. In the latter case, the cloud may represent a plurality of disaggregated servers which provide internet server 302 functionality and virtual storage/database functionality. The disaggregated servers are physical computer servers, which may have a processor, a memory, an I/O interface and/or a network interface. The features and variations of the processor, the memory, the I/O interface and the network interface are substantially similar to those described for the internet server 302. Differences may be where the disaggregated servers are optimized for throughput and/or for disaggregation.

Cloud services that provide the functionality of internet server 302 may be made accessible via an integrated cloud infrastructure. The cloud infrastructure may provide additional service abstractions such as Platform as a Service (“PAAS”), Infrastructure as a Service (“IAAS”), and Software as a Service (“SAAS”).

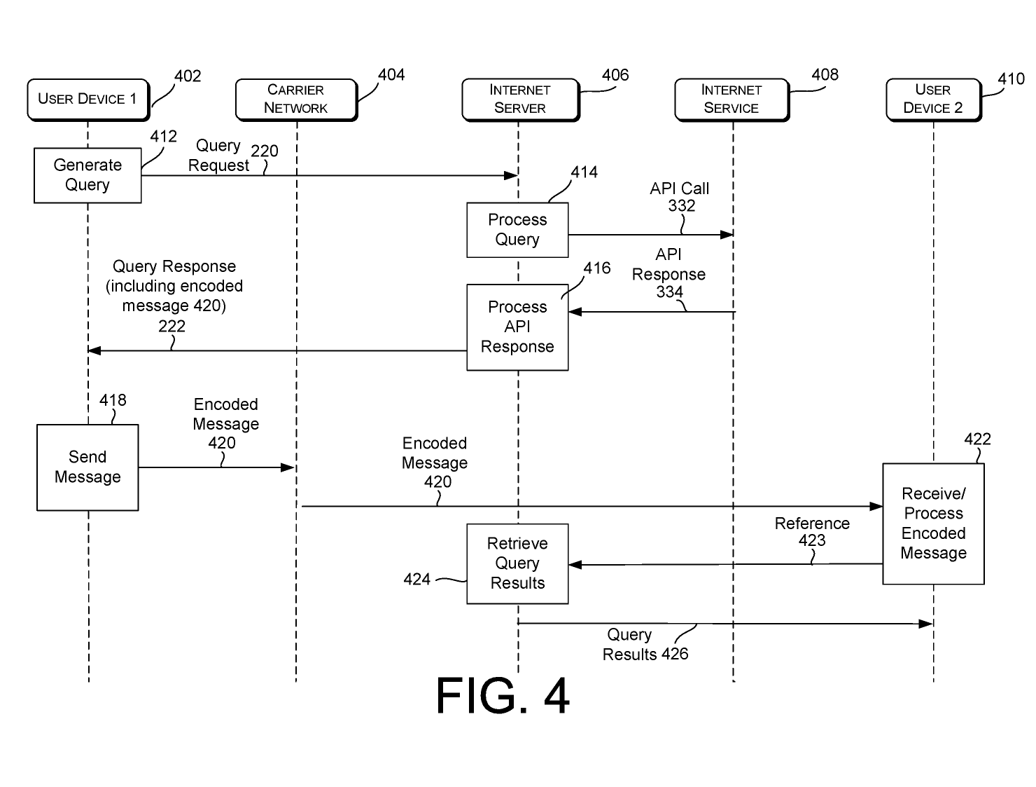

FIG. 4 is a message flow diagram of an example process for providing services for a messaging application with in-built web search. The message flow diagram of FIG. 4 illustrates communication between several networked devices, including user device 1 402, carrier network 404, internet server 406, internet service 408, and user device 2 410. User device 1 402 is one possible example of user devices 200A and/or 200B of FIG. 2. Carrier network 404 is one possible example of RAN 120 and/or core network 140 of FIG. 1. Internet server 406 is one possible example of internet server 302 of FIG. 3. Internet service 408 is one possible example of at least one of the internet services 336-342 of FIG. 3. User device 2 402 is one possible example of user devices 200A and/or 200B of FIG. 2.

As shown in process block 412, the messaging application 216 of user device 1 402 may generate a query. In one example, generating the query includes sending a query request 220 from the user device 1 402 to the internet server 406. As describe above, with reference to FIG. 3, the query request input module 318 may receive the query request 220, where the query request 220 includes one or more search terms and, optionally, an indication of one or more internet services to utilize for the query.

Next, in process block 414, the internet server 406 may process the received query request 220. In some examples, processing the query request 220 may include communicating with internet service 408 to obtain one or more query results. As discussed above, communicating with internet service 408 may include selecting an API interface based on the indication of the internet service included in the query request 220 and then generating an API call 332 that includes the one or more search terms.

Next, in process block 416 the internet server 406 receives one or more query results from the internet services. As shown, the query results may be included in one or more API responses 334 generated by the internet service 408. Processing the API response (i.e., process block 416) may also include generating one or more encoded messages that includes a reference to the one or more query results as well as maintaining a database (e.g., database 330 of FIG. 3) that correlates the generated reference to the one or more query results. The internet server 406 may then forward/send a query response 222 back to the messaging application 216 of the user device 1 402. In some examples, the query response 222 includes the one or more query results and one or more encoded messages.

Continuing with the description of FIG. 4, in process block 418, the messaging application 216 of the user device 1 402 then sends a message. In one example, the message includes an encoded message 420 that was formatted according to a messaging protocol (e.g., SMS protocol) by internet server 406. The user device 1 402 may then send the encoded message 420 to another user device (e.g., user device 2 410) via the carrier network 404.

As shown in process block 422, the user device 2 then receives the encoded message 420 via the messaging protocol. A messaging application installed on the user device 2 410 will then process the received encoded message 420. How the messaging application installed on the user device 2 410 processes the encoded message depends, in part, on whether the messaging application is compatible with the messaging application of the sending device (i.e., messaging application 216 of user device 1 402). For example, if the messaging application installed on user device 2 410 is a compatible messaging application (e.g., same as the messaging application 216 installed on user device 1 402 with in-built web search), then the messaging application of user device 2 410 may be configured to automatically recognize the encoded message 420 as one that refers to one or more query results. Thus, the messaging application of user device 2 410 may extract the reference 423 from the received encoded message 420 and send the reference 423 to the internet server 406 (e.g., via TCP/IP).

If, however, the messaging application of user device 2 410 is a non-compatible messaging application (e.g., a messaging application without in-built web search), then the non-compatible messaging application may display the encoded message as text to the user of user device 2 410. As describe above, the encoded message 420 may include a URL that includes a reference to the one or more query results. Thus, the user of user device 2 410 may activate the URL (either by selecting it or by pasting into a web browser), which then sends the reference 423 to the internet server 406 (e.g., as an HTTP message).

In process block 424, upon receiving the reference 423 from the user device 2 410 (either from a compatible messaging application or from a web browser), the internet server 406 then retrieves the query results. In one example, retrieving the query results includes retrieving one or more query results from database 330 of FIG. 3 based on the path/reference 423 received from the user device 2 410. The internet server 406 then forwards the one or more query results 426 to the user device 2 410. In some examples, communication between the internet server 406 and the user device 2 410 is performed according to one or more internet protocols (e.g., TCP/IP).

Upon receiving the query results 426, the user device 2 410 may display the query results (e.g., text, images, videos, audio, etc.) either via the compatible messaging application installed on user device 2 410 or via a web browser.

FIG. 5 is a diagram illustrating an example encoded message 500. Encoded message 500 is one possible example of an encoded message dynamically generated by the internet server 406. Encoded message 500 is also one possible example of encoded message 420 of FIG. 4 that is sent from user device 1 to user device 2 according to a messaging protocol (e.g., SMS, MMS, RCS, etc.).

As shown in FIG. 5, the internet server 302 may format the encoded message 500 to include one or more search terms 502. In one aspect, the search term 502 is the search term entered in the messaging application 216 by a user and forwarded to the internet server 302 in query request 220. Encoded message 500 is also shown as including a description 504 of one or more of the query results. In some examples, the description 504 may include additional information of at least one of the query results. For example, if the query result relates to a location (e.g., business), the description 504 may include a name associated with the location (e.g., business name) and, optionally an address of the location (e.g., business address). By way of another example, if the query result relates to a product available via an internet retailer, the description 504 may include a name of the product, a current price of the product, a brief description of the product, and so on.

Also included in the illustrated example of the encoded message 500 is a URL 506. In some examples, the URL 506 is dynamically generated by the internet server 302 and is provided to direct the recipient of the encoded message 500 (e.g., user device 2 410 of FIG. 4) to the internet server 302. By way of example, the illustrated URL includes a scheme component 508, a host name component 510, and a path/reference component 512.

In some aspects, the scheme component 508 identifies the protocol to be used to access the query results on the Internet 175. The scheme component 508 may be HTTP (without SSL) or HTTPS (with SSL). The host name component 510 identifies the host that holds the query results on the internet 175. For example, the host name component 510 may be the host name of internet server 302.

The path/reference component 512 identifies the query results in the host that the user device wants to access. In the illustrated example of FIG. 5, the reference included in the URL 506 is “YjN6d0Qc” and corresponds to the reference generated by the internet server 302 and maintained in database 330.

Encoded message 500 is also shown as including a message length 514. As mentioned above, the internet server 302 may be configured to format the encoded message 500 according to a messaging protocol utilized by the messaging application 216. In some examples, the messaging protocol (e.g., SMS) may have a maximum character limit. Thus, the internet server 302 may format the encoded message 500 to have a message length 514 that includes a number of characters that are equal to or less than the maximum character limit of the messaging protocol.

In operation, the internet server 302 may implement one or more schemes for formatting the encoded message 500 to ensure that the number of characters included in the encoded message 500 is equal to or less than the maximum character limit. For example, the internet server 302 may be configured to insert only the first search term included in the query request 220 as the search term 502 included in the encoded message 500. If the search term is greater than a first threshold character limit, then the internet server 302 may limit the search term 502 to the first threshold character limit while also removing the description 504 from the encoded message 500. In another example, the URL 506 is limited to a fixed character limit (e.g., 27 characters). That is, in some aspects, all URLs generated by the internet server 302 may have the same number of characters.

As mentioned above, the internet server 302 may be configured to generate multiple encoded messages, where each encoded message corresponds to a single query result included in the API response 334. However, in some examples, a user may desire to send multiple query results to another user. Thus, the example encoded message 500 may include an optional keyword(s) 505. In some examples keyword(s) 505 include readable text, such as “More at” to indicate that additional query results are available via the URL 506. In other aspects, the recipients messaging application (e.g., messaging application 216) may be configured to automatically recognize the keyword(s) 505 included in encoded message 500 and automatically download all the corresponding query results without further user input. That is, messaging application 216 may be configured to process a received encoded message 500 by searching the encoded message 500 for one or more known keywords 505. If the one or more keywords 505 are detected, the messaging application 216 may then be configured to automatically retrieve additional query results from the internet server 302. In some aspects, if no keywords 505 are detected by the messaging application 216, then the messaging application 216 may retrieve only a single query result corresponding to the reference 512 included in the URL 506.

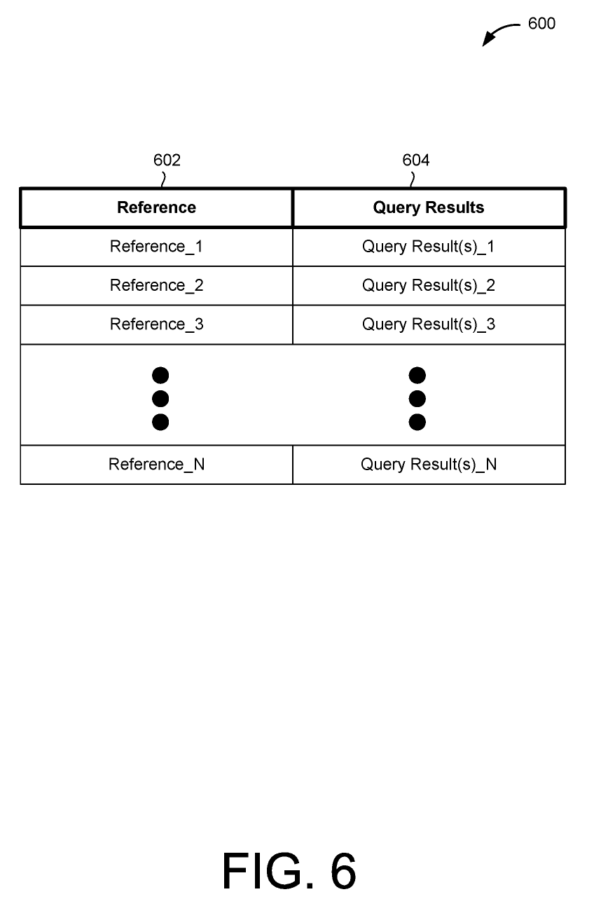

FIG. 6 is a diagram illustrating an example table 600 for correlating one or more references 602 to one or more query results 604 maintained by an internet server 302. Table 600 is one possible implementation of the data stored in database 330 of FIG. 3. As shown in FIG. 6, table 600 includes a plurality of references 602, where each reference 602 is correlated with at least one query result 604. As mentioned above, an API response, such as API response 334 may include multiple query results, where the internet server 302 may generate a encoded message and corresponding reference for each of the query results. Thus, in one example, each of the references 602 stored in table 600 may correspond to a single query result, where table 600 may include an additional column (not shown) that identifies multiple references 602 as being associated with the same API response 334. For example, continuing with the “coffee” example discussed above, the API response 334 from the internet directory service may identify multiple coffee shops. Thus, internet server 302 may be configured to generate an encoded message (e.g., encoded message 500 of FIG. 5) for each of the coffee shops and enter a separate reference 602 for each coffee shop into table 600. The table 600 may also include a unique ID (not shown) that identifies each of the coffee shops stored to table 600 as being part of the same query (i.e., part of the same API response 334).

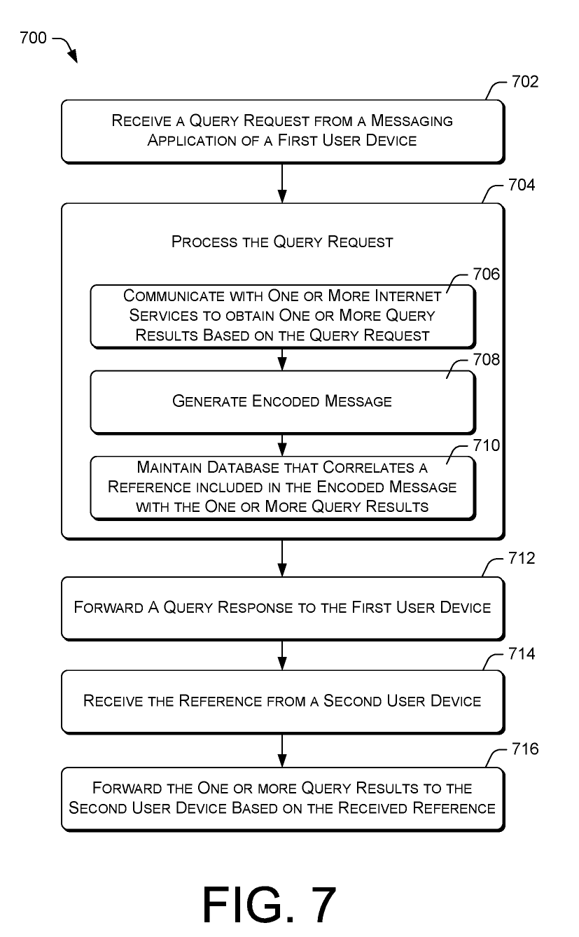

FIG. 7 is a flow chart illustrating an example process 700 for providing services for a messaging application with in-built web search. Process 700 is one example process performed by internet server 302 of FIG. 3. Process 700 will be described with reference to at least FIGS. 2, 3, and 7

In a process block 702, the query request input module 318 of internet server 302 receives a query request 220, where the query request 220 is received from a message application (e.g., messaging application 216) of a first user device (e.g., UE 200A and/or UE 200B of FIG. 2). In some examples, the query request 220 includes one or more search terms as well as an indication of which internet services with which the internet server 302 is to perform a query.

Next, in a process block 704, the internet server 302 processes the query request 220. As shown, process block 704 includes process blocks 706, 708, and 710. In process block 706, the internet services interface module 326 communicates with one or more internet services (i.e., internet service 336-342) to obtain one or more query results based on the query request. In particular, the internet services interface module 326 may select an API based on the indication of the desired internet service included in the query request 220 to generate an API call 332 that incorporates the one or more search terms of the query request 220. Upon receiving the API response(s) 334, process block 708 includes the internet server 302 generating one or more encoded messages (e.g., encoded message 500 of FIG. 5). Next, in process block 710, the internet server 302 may maintain a database (e.g., database 330 of FIG. 3) that correlates a reference (e.g., path/reference 512 of encoded message 500) to the one or more query results. In some examples, maintaining database 330 includes adding, modifying, and/or deleting one or more entries included in table 600 of FIG. 6. In one example, each entry included in table 600 may include an associated expiration date (e.g., one day) such that entries may be periodically removed by the internet server 302.

Still referring to process 700 of FIG. 7, process block 712 includes the query response output module 320 for forwarding/sending the query response 222 to the messaging application 216 of the user device. As mentioned above, the query response 222 may include the one or more query results (e.g., internet resources such as text, images, videos, audio, etc.) and the encoded message(s) (e.g., encoded message 500 of FIG. 5). Furthermore, as discussed above, the messaging application 216 may be configured to forward the encoded message 500 to another user device according to a messaging protocol (e.g., SMS, MMS, RCS, etc.). Thus, internet server 302 may format the encoded message 500 such that the encoded message 500 is compliant with the restrictions imposed by the messaging protocol utilized by the messaging application 216 (e.g., restricting number of characters included in the encoded message 500 to within a maximum character limit of the messaging protocol).

Next, in process block 714, the internet server 302 receives the reference (e.g., reference/path 512 of FIG. 5) to the one or more query results from a second user device (i.e., the user device that received the encoded message 500 from the messaging application 216 of the originating user device). In response to receiving the reference from the second user device, internet server 302 may retrieve the corresponding query results from database 330 and forward the retrieved query results to the second user device (i.e., process block 716).

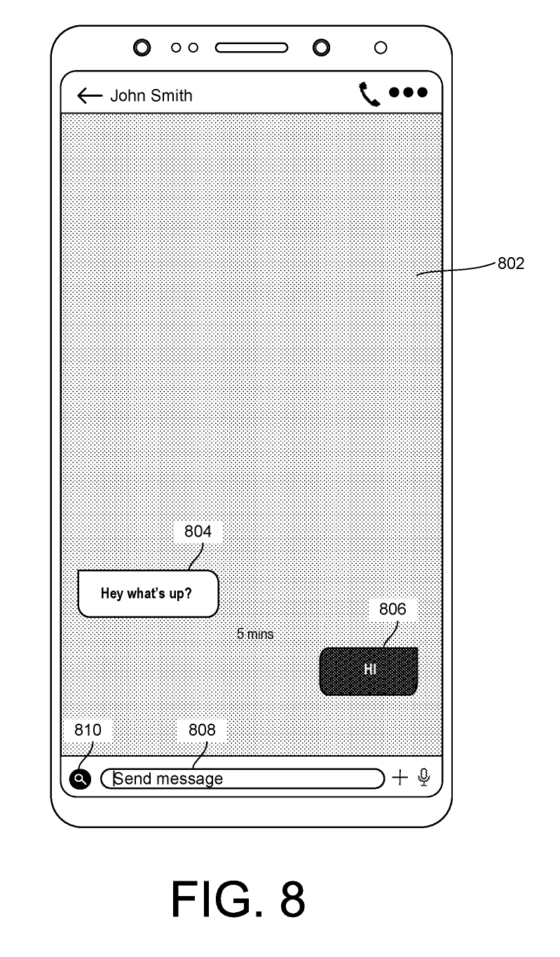

Further operations of the internet server 302 as well as of the messaging application 216 will now be described with reference to the various user interfaces illustrated in FIGS. 8-20. The user interfaces illustrated in FIGS. 8-17 are possible examples of user interface 218 of messaging application 216 of FIG. 2.

FIG. 8 is an example user interface 802 of a messaging application with in-built web search (e.g., messaging application 216 of FIG. 2). As shown in FIG. 8, user interface 802 may present one or more messages via a display of the user device. For example, FIG. 8 illustrates outgoing messages 806 on the right-side of the display, whereas incoming messages 804 are presented on the left-side of the display. Further included in user interface 802 is a text input field 808. In one example, text input field 808 is provided to allow a user of the user device to enter text to send to another user and/or to enter one or more search terms for performing a web search. Furthermore, a search option 810 is displayed on the user interface 802 as a virtual user interface element, such as a virtual button. However, in other implementations, search option 810 may be displayed on the user interface as other user interface elements such as a virtual toggle button, a picker, a pull-down menu, a text field, etc. In operation, the user may select the search option 810 to initiate a web search from within the messaging application 216, itself. In response to selecting the search option 810, the user interface 802 may display one or more internet service selection options which may be utilized for a web search. By way of example, FIG. 9 illustrates a plurality of internet service selection options 902-912 displayed on the user interface 802 as virtual user interface elements, such as virtual buttons. However, in other implementations, the internet service selection options 902-912 may be displayed on the user interface 802 as virtual toggle buttons, pull-down menus, pickers, text fields, etc. In the illustrated example of FIG. 9, each internet service selection option may be displayed on user interface 802 as a unique icon (e.g., logo, picture, etc.) associated with an internet service. Each internet service selection option 902-912 may further include text that identifies the associated internet service (e.g., “AMAZON”, “EBAY”, “BING”, etc.). In some examples, the internet services included on user interface 802 are internet services with which internet server 302 is capable of communicating with via an associated API.

Further illustrated as included in user interface 802 is an internet service configuration option 914. In some examples, the number of available internet services may exceed the display capabilities of the user interface 802. That is, more internet services may be available than can be reasonably displayed on the user interface 802. Thus, internet service configuration option 914 may cause user interface 802 to display a configuration menu (not illustrated) that allows the user to select which internet services are presented on the user interface 802 and/or to configure the order in which the internet service selection options 902-912 are displayed on user interface 802.

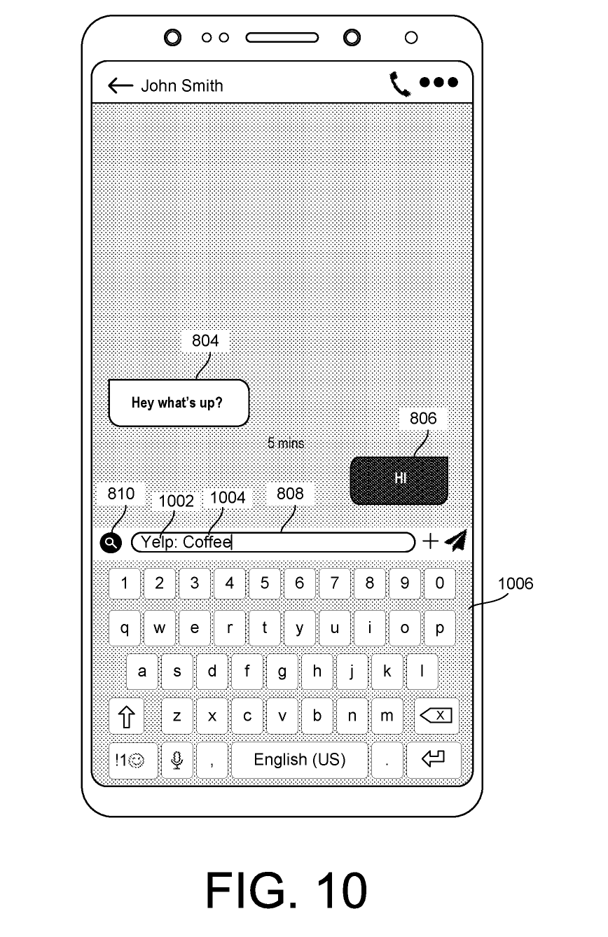

In response to selecting at least one of the internet service selection options 902-912, the user interface 802 may populate the text input field 808 with an identifier of the selected internet service. For example, FIG. 10 illustrates the text input field 808 as being populated with an identifier 1002 that identifies that the user has selected the “YELP” internet service. The user interface 802 may further display a virtual keyboard 1006 to allow the user to enter one or more search terms 1004 into the text input field 808. In the illustrated example of FIG. 10, the user has entered a search term “coffee”.

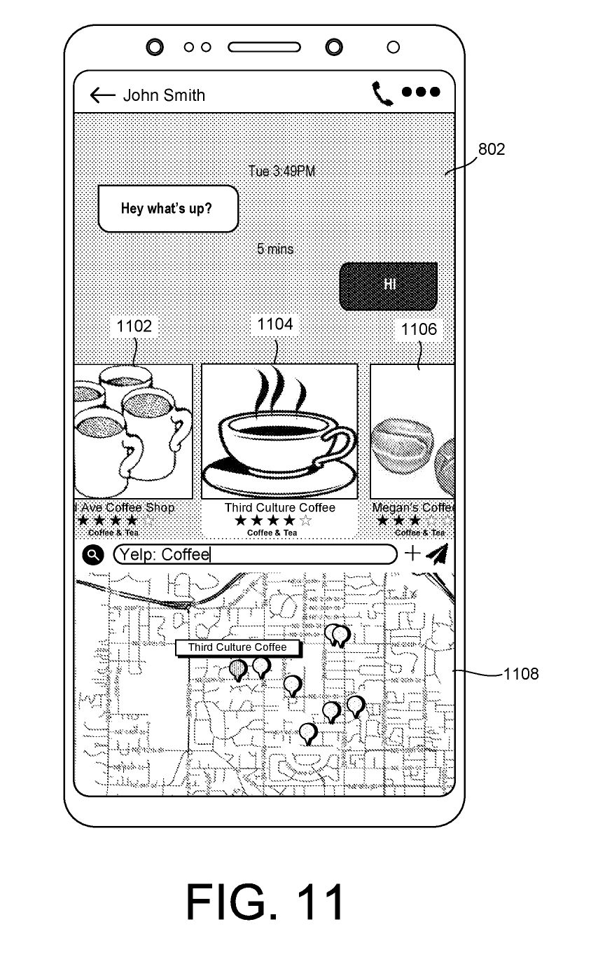

In response to entering the search term 1004, the messaging application 216 may generate the query request 220 that includes the search term 1004 (e.g., “coffee”) as well as an indication of the selected internet service (e.g., “YELP”). The messaging application 216 then sends the query request 220 to the internet server 302 (e.g., via an internet protocol, such as TCP/IP). The messaging application 216 then receives the query response 222 that includes one or more query results. The one or more query results may then be displayed as one or more virtual user interface elements on user interface 802 of the messaging application 216. For example, FIG. 11 illustrates several query results displayed on the user interface 802 as a series of slidable cards 1102-1106. In one aspect, each slidable card 1102-1106 corresponds to at least one query result. In the particular example of FIG. 11, each slidable card 1102-1106 corresponds to a coffee shop that was returned as a query result obtained via the API responses 334 at the internet server 302. In one aspect, each slidable card 1102-1106 may display a variety of information dependent on the API corresponding to the utilized internet service. For example, in the illustrated example of FIG. 11, each query result includes an image associated with the coffee shop, an average rating, a name of the coffee shop, as well as an associate category (e.g., “coffee & tea”). The formatting and information included in each slidable card 1102-1106 may depend on the internet service selected. For example, assuming an internet retailer was selected as the internet service, then each slidable card 1102-1106 may display a name of the product, an image of the product, a current price of the product, as well as an average rating of the product.

Furthermore, if the query results relate to a physical location (e.g., business, school, government agency, etc.) then the user interface 802 may be configured to display a map 1108. In one example, the map 1108 is an interactive map that allows the user to pan, zoom, or otherwise interact with the virtual map 1108. Furthermore, the user interface 802 may overlay one or more markers corresponding to the query results (e.g., one marker for each slidable card 1102-1106).

In another example, the slidable cards 1102-1106 may be configured to be interactive virtual user interface elements. For example, the user interface 802 may be configured to highlight a corresponding marker displayed on the map 1108 based on which slidable card 1102-1106 is currently selected by the user. Furthermore, the user interface 802 may be configured to allow the user to scroll through multiple slidable cards in response to a swipe-left and/or swipe-right gesture performed by the user. That is, the user interface 802 may be configured to only display a limited number of slidable cards at a time (e.g., 2.5). However, additional query results may have been included in the query response 222 received from the internet server 302. Thus, the user interface 802 may allow the user to view additional sliding cards by displaying addition slidable cards in response to one or more gestures detected via a touch screen display of the user device.

Once the user has viewed the query results (e.g., as slidable cards 1102-1106), the user may decide to forward all the query results to another user device. Accordingly, in one aspect, the user interface 802 may include a send option 1202 displayed on user interface 802 as a virtual button. However, send option 1202 may be implemented as one or more other user interface elements, such as a pull-down menu, picker, or as a gesture input.

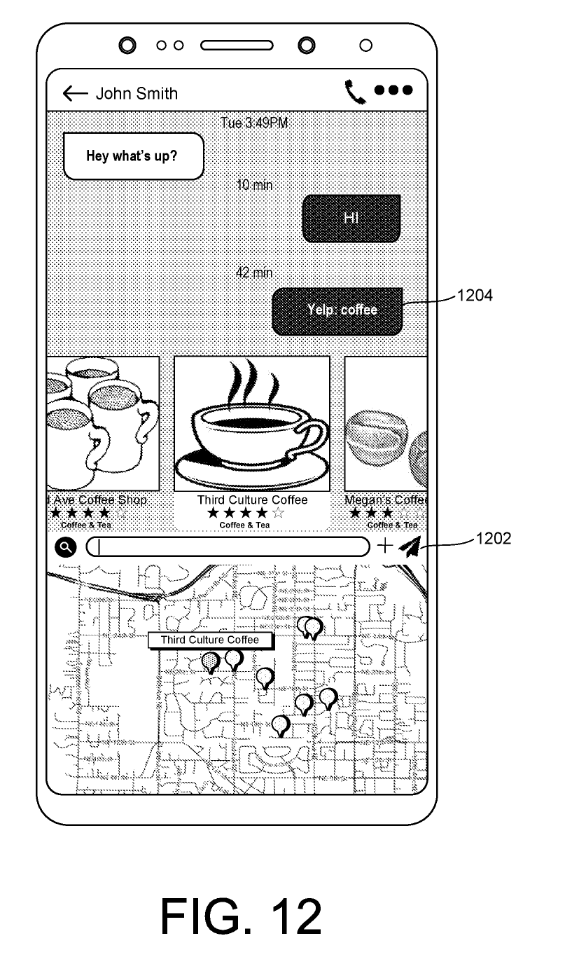

In response to selecting the send option 1202, the messaging application 216 may send the encoded message (e.g., encoded message 500) to another user device via a messaging protocol (e.g., SMS). In addition, the user interface 802 may display an indication that the query results were sent to the other user device. For example, FIG. 12 illustrates an indication 1204 that the query results associated with the internet server “YELP” using the search term “coffee” were sent.

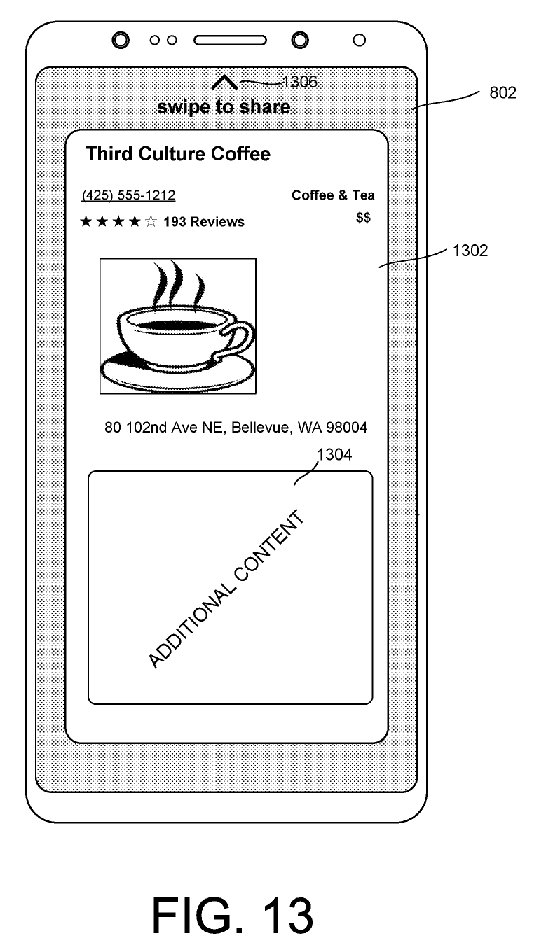

FIG. 13 is an example user interface 802 of a messaging application 216 with in-built web search for displaying additional information 1302 of a query result and user interface components 1306 for sending a single query result to another user device. In one example, user interface 802 may be configured to display additional information 1302 in response to a user selecting a slidable card (e.g., slidable cards 1102-1106 of FIG. 11). As shown in FIG. 13, additional information other than was included in the slidable cards 1102-1106 may be presented on user interface 802. For example, FIG. 13 includes additional information 1302 corresponding to slidable card 1104. As shown, additional information 1302 may include a phone number and full address of the business. Additional information may also include additional content 1304. In one example, additional content 1304 may include advertisements that may or may not be related to the corresponding query result of the slidable card 1104.

Furthermore, the user interface 802 of FIG. 13 may provide the user with the ability to forward a single result to another user device. That is, as discussed above with reference to FIG. 12 a user may select the send option 1202 to send multiple query results to another user device. However, a user may desire to send just one of the query results. Thus, in one example, the user interface 802 of FIG. 13 includes an indication 1306 to allow a user to send a single query result in response to a gesture command (e.g., swipe up).

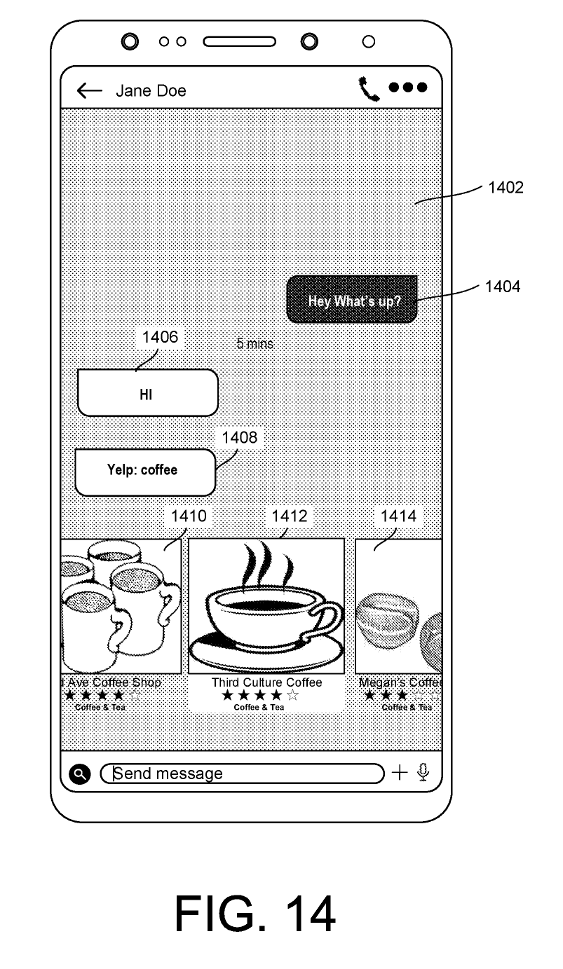

FIG. 14 is an example user interface 1402 of a messaging application with in-built web search for displaying query results as multimedia content received from another user device. In one aspect, the user interface 1402 is of a messaging application that is the same as, or at least compatible with, the messaging application 216 of FIG. 2. That is, messaging application 216 may include in-built web search, as well as the ability to display query results as multimedia content within the messaging application, itself. As shown in FIG. 14, the user interface 1402 may display messages 1404-1408 as well as the query results (e.g., as slidable cards 1410-1414). In one example, the messaging application of FIG. 14 may receive the encoded message 500 from another user device via a messaging protocol (e.g., SMS protocol). In response to receiving the encoded message 500, the messaging application of FIG. 14 may communicate with the internet server 302 to retrieve the one or more query results. As discussed above, communicating with the internet server 302 may include sending the reference (e.g., reference 512) to the internet server 302. In response to receiving the reference 512, the internet server 502 may then provide the query results to the messaging application of FIG. 14, which are then display via user interface 1402 as slidable cards 1410-1414.

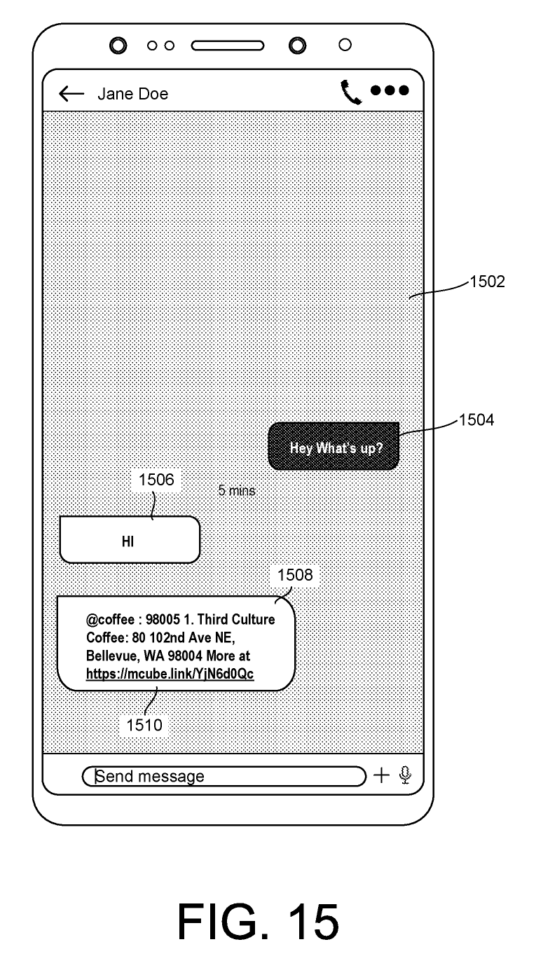

FIG. 15 is an example user interface 1502 of a messaging application without in-built web search for displaying an encoded message providing a reference to query results as a text message received from another user device. That is, user interface 1502 may correspond to a messaging application that is unable to display multimedia content from within the user interface 1502 itself. Thus, the user interface 1502 may display the encoded message 1508 that is received via the messaging protocol (e.g., SMS) as text. In some examples, the messaging application of FIG. 15, while not able to display multimedia content, may still recognize a URL. Thus, in some aspects, the messaging application of FIG. 15 may recognize the URL 1510 included in the encoded message 1508 as a URL. In some examples, the user device of FIG. 15 may be configured to launch a web browser in response to the user selecting the URL 1510. Launching the web browser may initiate the web browser communicating (e.g., via HTTP messages) with the web service module 324 of the internet server 302 to display the one or more query results within the web browser.

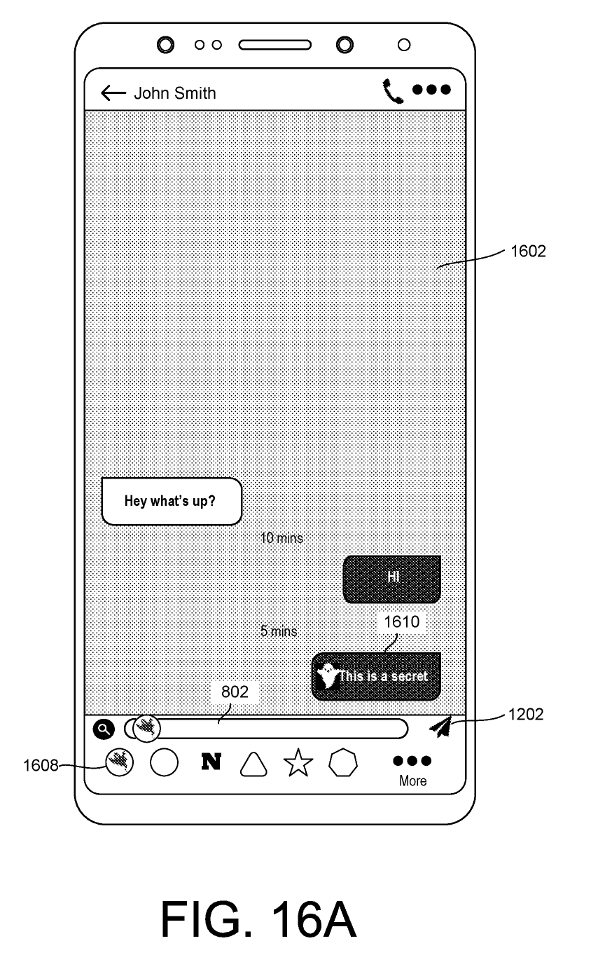

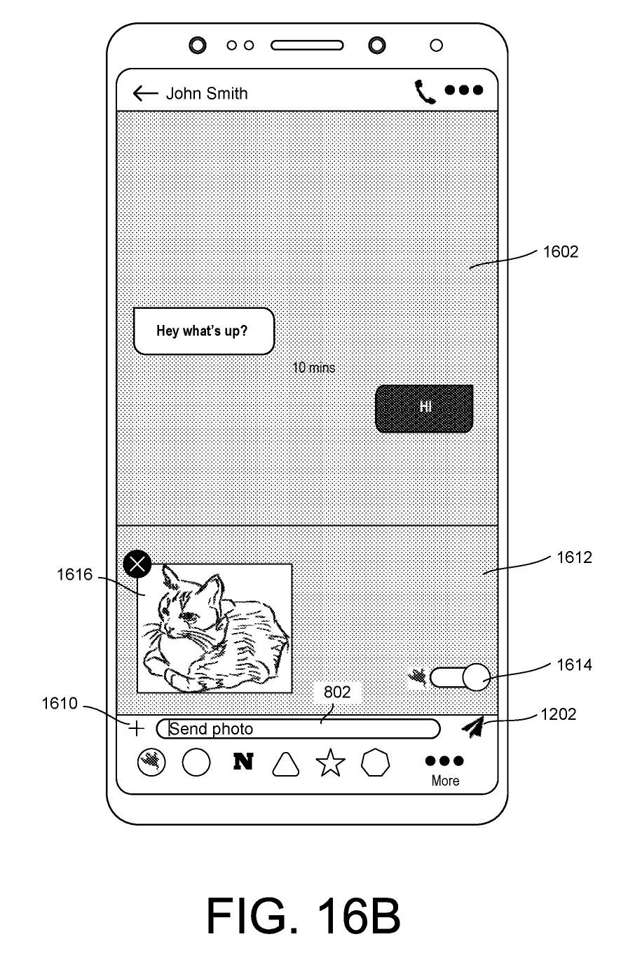

FIG. 16A is an example user interface 1602 of a messaging application with user interface components for allowing the generation of transient messages. In some situations, a user may desire to send a transient message to another user. However, the messaging protocol utilized by the messaging application may not provide native transient message functionality. As used herein, a transient message refers to a message that is configured to “disappear” or “self-destruct” after an elapsed period of time.

User interface 1602 is one possible implementation of user interface 218 of FIG. 2. As shown in FIG. 16A, the user interface 1602 may include a transient message initiator 1608 displayed on the user interface 1602 as a virtual button user interface element. However, in other implementations, the transient message initiator 1608 may be displayed on the user interface 1602 as other user interface elements, such as a virtual toggle button, a pull-down menu, a picker, a text field, etc. In response to a user selecting the transient message initiator 1608, the user interface 1602 may present one or more virtual user interface elements to allow the user to specify a maximum time period for the transient message. By way of example, in response to a press-and-hold gesture received via the transient message initiator 1608, the user interface 1602 may display a user interface element, such as one or more buttons (e.g., radio, check box, etc.), a slider, a list box, a spinner, a drop-down list, a menu, a text box, and/or a combo box to allow the user to input a maximum time period to be associated with the message.

As mentioned above, the content included in the transient message may include any media, such as a text message, video, audio, link, image, and/or other file. Thus, when the user has entered the content to be sent, (e.g., text is entered via the text input field 802), the user may select the send button 1202 to send a text message as a transient text message.

In response to selecting the send button 1202, the messaging application (e.g., messaging application 216) may generate a transient message package that is sent to the internet server 302. In some aspects, the transient message package includes the content (e.g., text message), an indication that the text message is to be transient, and an indication of the intended recipient (e.g., phone number). In addition, the transient message package may further include the maximum time period associated with the content. In response to receiving the transient message package, the internet server 302 may store the content to memory (e.g., memory 314) and generate an encoded message, where the encoded message includes a reference to the stored content. In one example, the reference is the path included in a dynamically generated URL. The internet server 302 may also maintain a database that correlates the reference to the stored content. The internet server 302 may then forward the encoded message to the intended recipient according to a messaging protocol (e.g., SMS). As will be described in further detail below, the recipient may then return the reference included in the encoded message (e.g., via an HTTP message based on the URL) to the internet server 302, where the internet server 302 then retrieves the stored content (e.g., text message) and sends it to the recipient.

As mentioned above, the content included in the transient message may include any media, such as a text message, video, audio, link, image, and/or other file. FIG. 16B illustrates an example of user interface 1602 that allows a user to generate a transient message that includes content of an image 1616. In operation, the user interface 1602 may display an additional content button 1610. In response to selecting the additional content button 1610, the messaging application 216 may provide the user with one or more options for selecting additional content (e.g., photo gallery with images available on the user device, files available on the user device, video gallery with videos available on the user device, etc.). In response to selecting the content (e.g., image 1616), the user interface 1602 may display a preview area 1612 that includes a preview of the selected content (e.g., image 1616). The user interface 1602 may also display an additional transient message initiator 1614 within or near the preview area 1612. As shown in FIG. 16B, the additional transient message initiator 1614 is displayed on the user interface 1602 as a virtual toggle button user interface element. However, in other implementations, the additional transient message initiator 1614 may be displayed on the user interface 1602 as other user interface elements, such as a virtual check box button, a pull-down menu, a picker, etc.

Thus, when the user has entered the content to be sent, (e.g., image 1616), the user may select the send button 1202 to send the image 1616 as a transient message.

In response to selecting the send button 1202, the messaging application (e.g., messaging application 216) may generate a transient message package that is sent to the internet server 302. In the example of FIG. 16B, the transient message package includes the content (e.g., image 1616), an indication that the text message is to be transient, and an indication of the intended recipient (e.g., phone number). In addition, the transient message package may further include the maximum time period associated with the content. In response to receiving the transient message package, the internet server 302 may store the content (e.g., image 1616) to memory (e.g., memory 314) and generate an encoded message, where the encoded message includes a reference to the stored image 1616. In one example, the reference is the path included in a dynamically generated URL. The internet server 302 may also maintain a database that correlates the reference to the stored image 1616. The internet server 302 may then forward the encoded message to the intended recipient according to a messaging protocol (e.g., SMS).

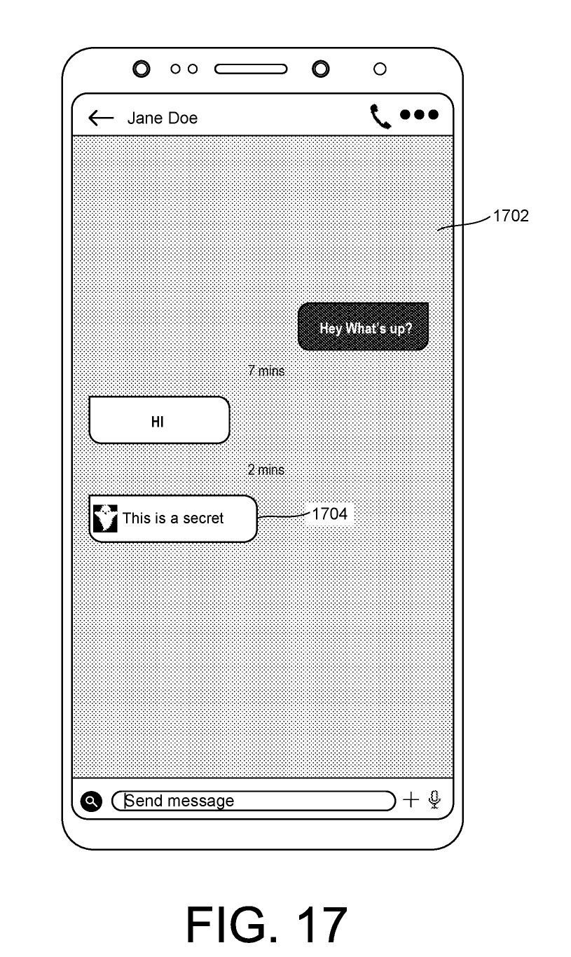

FIG. 17 is an example user interface 1702 of a messaging application for displaying transient messages. In one example, the user interface 1702 corresponds to a messaging application that is the same as or at least compliant with the messaging application 216 of FIG. 2. Thus, upon receiving the encoded message that includes a reference to the content stored at the internet server 302, the user device of FIG. 17 may communicate with the internet server 302 to retrieve the content. In one example, the transient content (e.g., text message 1704) is then displayed on the user interface 1702.

In operation, the internet server 302 may be configured to initiate a transient timer corresponding to the stored content in response to receiving the reference to the stored content. That is, upon receiving a communication from the recipient that includes the reference to the stored content, the internet server 302 may begin a timer. Once a time period, as indicated by the transient timer, has elapsed, the internet server 302 may communicate with the messaging application of FIG. 17 to delete, remove, or otherwise prevent the display of the transient text message 1704.

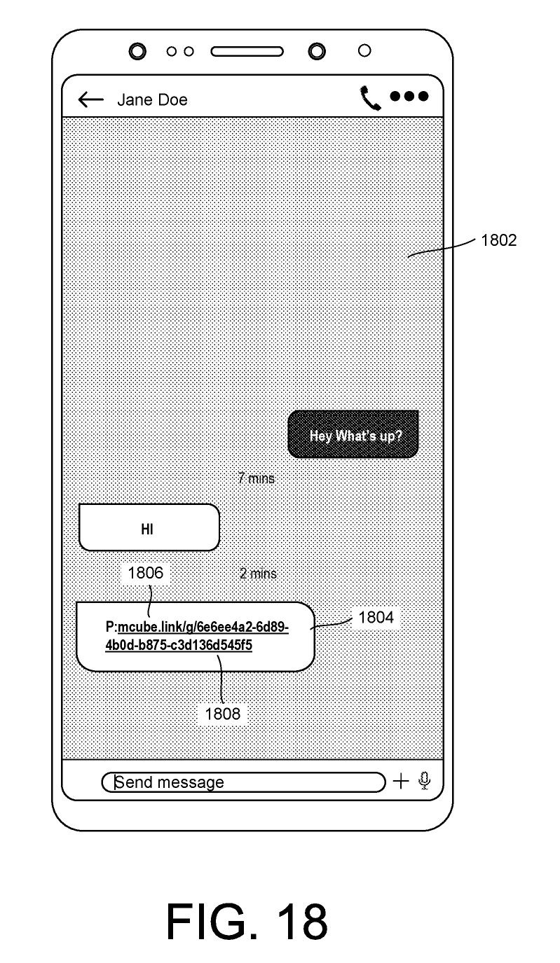

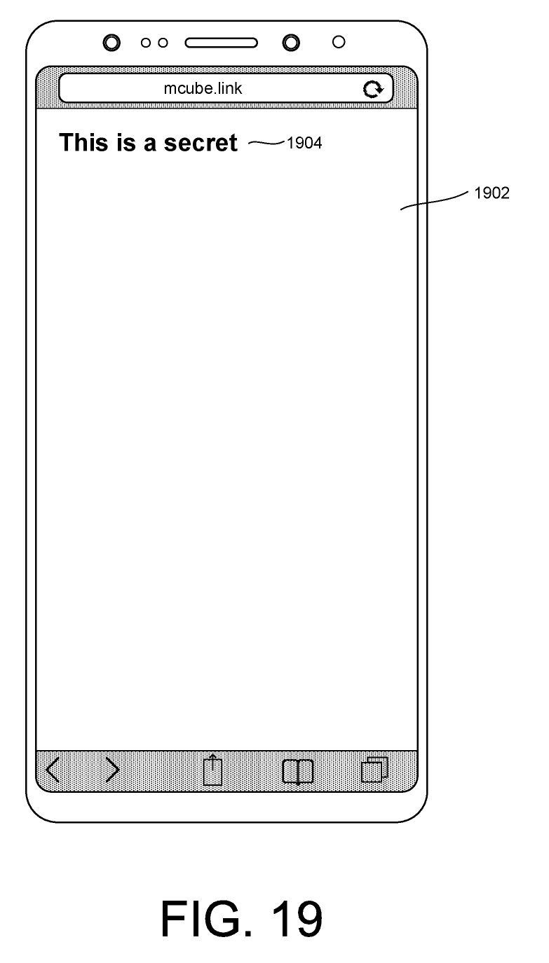

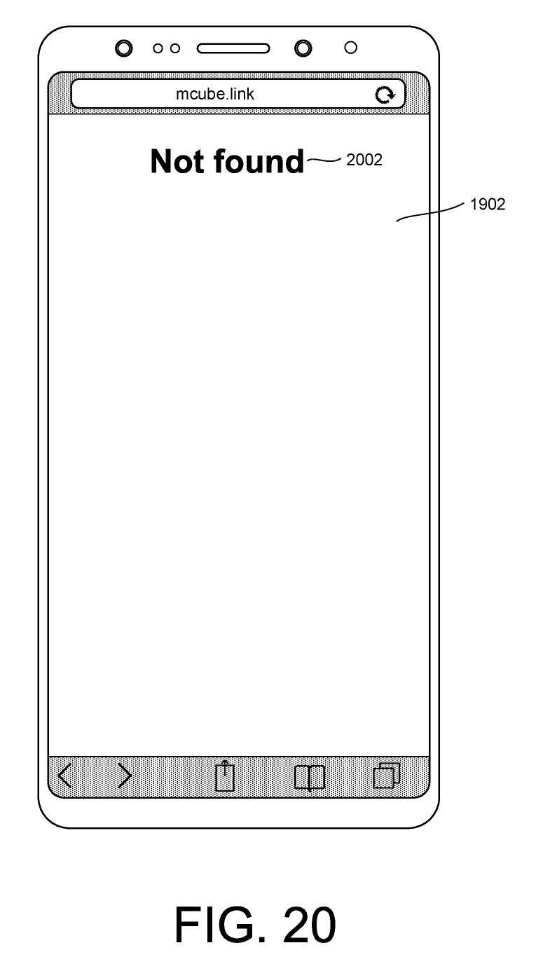

FIG. 18 is an example user interface 1802 of a messaging application for displaying a reference to a transient message. User interface 1802 corresponds to a messaging application that does not include the ability to display transient messages. That is, user interface 1802 may correspond to a messaging application that is unable to display transient messages within the user interface 1802 itself. Thus, the user interface 1802 may display the encoded message 1806 that is received via the messaging protocol (e.g., SMS) as text. In some examples, the messaging application of FIG. 18, while not able to display transient messages, may still recognize a URL. Thus, in some aspects, the messaging application of FIG. 18 may recognize the URL 1808 included in the encoded message 1804 as a URL. In some examples, the user device of FIG. 18 may be configured to launch a web browser in response to the user selecting the URL 1808. Launching the web browser may initiate the web browser communicating (e.g., via HTTP messages) with the transient message processing module 322 of the internet server 302 to display the transient message within the web browser. For example, FIG. 19 illustrates an example user interface 1902 of a web browser for displaying a transient text message 1904. In one example, the web browser of FIG. 19 communicates with the transient message processing module 322 via one or more HTTP messages to display the transient text message 1904 within the web browser provided the time period corresponding to the transient text message has not expired. If the time period corresponding to the transient text message has indeed expired, the internet server 302 may be configured to display a default message 2002 as shown in FIG. 20.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computer-implemented method, performed by an internet server, the method comprising:
receiving, at the internet server, a query request, wherein the query request is received from a messaging application of a first user device;
processing the query request, wherein processing the query request includes:
communicating with one or more internet services to obtain one or more query results based on the query request;
generating an encoded message that includes a reference to the one or more query results; and
maintaining a database that correlates the reference with the one or more query results;
forwarding a query response to the first user device, wherein the query response includes the one or more query results and the encoded message;
receiving, at the internet server, the reference to the one or more query results from a second user device; and
forwarding the one or more query results to the second user device based on the received reference.

2. The computer-implemented method of claim 1, wherein communicating with the one or more internet services comprises:
selecting an application programming interface (API) from among a plurality of API interfaces, wherein the selected API interface corresponds to at least one of the one or more internet services;
generating an API call based on the selected API interface; and
receiving an API response from the at least one of the one or more internet services, wherein the API response includes the one or more query results.

3. The computer-implemented method of claim 2, wherein the query request received from the first user device includes one or more search terms and an indication of at least one internet service of the one or more internet services.

4. The computer-implemented method of claim 3, wherein selecting the API from the plurality of API interfaces is based on the indication of the at least one internet service included in the query request.

5. The computer-implemented method of claim 3, wherein generating the API call includes incorporating at least one of the one or more search terms into the API call.

6. The computer-implemented method of claim 1, wherein the messaging application of the first user device is configured to forward the encoded message to the second user device via a messaging protocol, and wherein generating the encoded message by the internet server comprises formatting the encoded message according to the messaging protocol.

7. The computer-implemented method of claim 6, wherein the messaging protocol has a maximum character limit, and wherein formatting the encoded message comprises formatting the encoded message to include a number of characters that is equal to or less than the maximum character limit.

8. The computer-implemented method of claim 6, wherein generating the encoded message by the internet server comprises formatting the reference to include a uniform resource locator (URL) to direct the second user device to the internet server.

9. The computer-implemented method of claim 8, wherein the URL comprises:
a host name of the internet server; and
a path that identifies the one or more query results.

10. The computer-implemented method of claim 9, wherein forwarding the one or more query results to the second user device based on the received reference comprises retrieving the one or more query results from the database based on the path included in the URL of the received reference.

11. The computer-implemented method of claim 1, further comprising:
receiving, at the internet server, a transient message package, wherein the transient message package is received from the messaging application of the first user device, and wherein the transient message package includes content, an indication that the content is to be transient, and an indication of an intended recipient;
storing the content;
generating an additional encoded message, wherein the additional encoded message includes a reference to the stored content;
forwarding the additional encoded message to the intended recipient according to a messaging protocol;
receiving, at the internet server, the reference to the stored content from the intended recipient;
initiating a transient timer corresponding to the stored content in response to receiving the reference to the content;
providing the stored content to the intended recipient in response to determining that a time period, as indicated by the transient timer, has not exceeded a maximum time period for the stored content; and
preventing access, by the intended recipient, to the stored content in response to determining that the time period has exceeded the maximum time period.

12. The computer-implemented method of claim 11, wherein the transient message package further includes an indication of the maximum time period for the content.

13. The computer-implemented method of claim 11, wherein the messaging protocol is Short Messaging Service (SMS) protocol.

14. The computer-implemented method of claim 1, wherein the one or more internet services comprises at least one internet service selected from the group consisting of: an internet search engine, an internet retailer, an internet directory service, an internet database, an internet review service, an internet news service, an internet classified advertisements service, an internet dating service, an internet blog service, an internet forum service, an internet social networking service, an internet video sharing service, and an internet wiki service.

15. The computer-implemented method of claim 1, wherein the messaging application of the first user device is configured to display, via a user interface of the messaging application, the one or more query results as a series of slidable cards, where each slidable card corresponds to a single query result and displays information related to a respective query result.

16. The computer-implemented method of claim 1, wherein communicating with the one or more internet services comprises obtaining a first plurality of query results based on the query request, the method further comprising:
determining which of the first plurality of query results are the most relevant to obtain a second plurality of query results, wherein the reference to the one or more query results includes a reference to the second plurality of query results.

17. The computer-implemented method of claim 16, wherein determining which of the first plurality of query results are the most relevant comprises applying a machine learning technique to the first plurality of query results.

18. An internet server, comprising:
at least one processor; and
at least one memory coupled to the at least one processor, the at least one memory having instructions stored therein, which when executed by the at least one processor, direct the internet server to:
receive a query request, wherein the query request is received from a messaging application of a first user device, and wherein the query request comprises one or more search terms;
process the query request, wherein the instructions to process the query request includes instructions to:
communicate with one or more internet services to obtain one or more query results based on the query request;
generate an encoded message in accordance with a messaging protocol, wherein the encoded message includes:
at least one of the one or more search terms; and
a reference to the one or more query results; and
maintain a database that correlates the reference with the one or more query results;
forward a query response to the first user device, wherein the query response includes the one or more query results and the encoded message, wherein the messaging application of the first user device is configured to send the encoded message to a second user device via the messaging protocol;
receive the reference to the one or more query results from the second user device; and
forward the one or more query results to the second user device based on the received reference.

19. The internet server of claim 18, wherein the query request received from the first user device further includes an indication of at least one internet service of the one or more internet services, and wherein the instructions to communicate with the one or more internet services comprises instructions to:
select an application programming interface (API) from among a plurality of API interfaces based on the indication of the at least one internet services;
generate an API call based on the selected API interface, wherein the API call incorporates at least one of the one or more search terms; and
receive an API response from the at least one of the one or more internet services, wherein the API response includes the one or more query results.

20. One or more non-transitory computer-readable media storing computer-executable instructions, which when executed by the at least one processor of an internet server, direct the internet server to:
receive a query request, wherein the query request is received from a messaging application of a first user device, and wherein the query request comprises one or more search terms and an indication of at least one internet service;
process the query request, wherein the instructions to process the query request includes instructions to:
select an application programming interface (API) from among a plurality of API interfaces based on the indication of the at least one internet service included in the query request;
generate an API call based on the selected API interface, wherein the API call includes at least one of the one or more search terms;
receive an API response from the at least one internet service in response to generating the API call, wherein the API response includes one or more query results;
generate an encoded message in accordance with a short messaging services (SMS) protocol, wherein the encoded message comprises:
at least one of the one or more search terms; and
a reference to the one or more query results, wherein the reference includes a uniform resource locator (URL) that includes a host name of the internet server and a path that identifies the one or more query results; and
maintain a database that correlates the reference with the one or more query results;
forward a query response to the first user device, wherein the query response includes the one or more query results and the encoded message, wherein the first user device is configured to send the encoded message to a second user device via the SMS protocol;
receive, at the internet server, the reference to the one or more query results from the second user device;
retrieve the one or more query results from the database based on the reference received from the second user device; and
forward the retrieved one or more query results to the second user device.
